(19) United States
(12) Patent Application Publication
(10) Pub. No.: US 2011/0127693 A1
(43) Pub. Date: Jun. 2, 2011

(54) METHOD OF MANUFACTURING THROTTLE VALVES AND THROTTLE BODIES

(75) Inventors: Hiroki SHIMOTO, Nagoya-shi (JP); Masashi OZEKI, Obu-shi (JP); Kenji TAKEUCHI, Nagoya-shi (JP); Kenji MIYAMOTO, Nagoya-shi (JP); Yoshinori KUBOTA, Okazaki-shi (JP); Hideki ASANO, Tokai-shi (JP); Takanori KAWADA, Obu-shi (JP); Hiroki SHIMADA, Obu-shi (JP); Hiroshi TANIMURA, Kariya-shi (JP); Yukimasa FUKAYA, Hekinan-shi (JP); Tsuyoshi ARAI, Nagoya-shi (JP); Naoki HIRAIWA, Toyokawa-shi (JP)

(73) Assignee: DENSO CORPORATION, Kariya-shi (JP)

(21) Appl. No.: 12/940,122

(22) Filed: Nov. 5, 2010

(30) Foreign Application Priority Data
Nov. 5, 2009 (JP) 2009-253841
Nov. 20, 2009 (JP) 2009-264716

(51) Int. Cl. B29C 45/14

(52) U.S. Cl. 264/271.1

(57) ABSTRACT

A method of molding a part, such as throttle valve and a throttle body, of a throttle device includes resin-molding the part by an injection molding process using a molding die. The molding die has a mold cavity having a cavity portion for molding a base that may protrude from the resin part. The cavity portion for molding the base communicates with an injection gate, from which molten resin is injected into the mold cavity. The configuration of at least one of the base and the injection gate is determined such that a projection formed at the injection gate can be removed without substantially damaging the resin part.

This application claims priority to Japanese patent application serial numbers 2009-253841 and 2009-264716, the contents of which are incorporated herein by reference.

### BACKGROUND OF THE INVENTION

1. Field of the Invention

The present invention relates to method of manufacturing throttle valves and throttle bodies that are parts of a throttle device used for controlling flow of intake air into an internal combustion engine.

2. Description of the Related Art

Resin materials are increasingly used as materials of peripheral parts of an internal combustion engine mounted to an automobile or the like for the purpose of reducing the weights of the peripheral parts. As part of this increased use of the resin materials, a resin material has been used for a throttle valve (called “butterfly valve”) of a throttle device. The throttle valve is rotatably disposed within an intake air passage defined in the throttle device and can rotate to open and close the intake air passage. Japanese Laid-Open Patent Publication No. 2005-140061 discloses a known method of manufacturing a throttle valve made of resin. According to the method disclosed in this publication, the throttle valve is manufactured by an injection molding process using an insertion molding technique, so that a metal throttle shaft is inserted into a central portion of a disk-shaped valve body made of resin. More specifically, the valve body includes a shaft cover portion covering the outer circumference of the throttle shaft defining a rotational axis and also includes a pair of semicircular disk-shaped portions disposed on opposite sides of the shaft cover portion and extending opposite directions therefrom. According to the method of the above publication, the throttle valve is injection-molded by injecting molten resin into a cavity configured for molding the shaft cover portion via two injection gates positioned to be opposed to each other in a direction perpendicular to the axial direction of the throttle shaft. The injection gates are directly opposed to the top of the shaft cover portion and are positioned on the same axis. After solidification of the molten resin, projections formed at the injection gates are cut and removed.

It is also known to use a resin material for a throttle body of a throttle device. Japanese Laid-Open Patent Publication No. 2006-44047 discloses a known method of manufacturing a throttle body made of resin. According to the method disclosed in this publication, the throttle body and throttle valve are simultaneously molded by using an injection molding process. More specifically, a molding die is designed such that molten resin is first injected into a cavity for molding the throttle body. The molten resin injected into the cavity for molding the throttle body is further guided into a cavity for molding the throttle valve, so that the throttle body and the throttle valve can be simultaneously molded. Injection gates for injecting the molten resin into the cavity for molding the throttle body directly communicate with a cylindrical bore wall portion of the throttle body to be formed. According to this publication, the bore wall portion has a fixed inner diameter throughout the vertical length of the bore wall portion. Although not explicitly disclosed in this publication, after solidification of the molten resin within the molding die, a molded product may be removed from the molding die. The molded product has projections formed at the injection gates, which still remain immediately after removal of the molded product from the molding die. Therefore, removing the projections finishes the molded product. In general, the projections are cut or bent to be broken for removing the same.

Although not intended to manufacture a throttle valve or a throttle body, Japanese Laid-Open Patent Publication No. 2009-34970 discloses a method of injection-molding a product that is plated after the molding process. More specifically, the method of this publication is used for manufacturing a part of an electronic device, such as a shutter button of a digital camera. According to this method, a base projecting from a surface of a body is formed on a molded product, and an injection gate is positioned at the base. According to the description in this publication, when a projection formed at the injection gate after solidification of the molten resin is broken, potential removal of a plated film may be caused only at a portion corresponding to the base

Similarly, although not intended to manufacture a throttle valve or a throttle body, Japanese Laid-Open Patent Publication No. 1-234220 discloses a method of injection-molding a precise plastic product. According to the method of this publication, an injection gate is configured to have a triangular shape, and cutting of a projection formed at the injection gate is made from the side of a part having a narrowest width (i.e., the side of an apex of a triangle).

However, in the case of Publication No. 2005-140061, when the projections formed at the injection gates are broken for removal after solidification of the molten resin, portions around the projections may also be removed together with the projections in a manner ripped from the valve body because the injection gates are directly opposed to the valve body. In the case of Publication No. 2006-44047, the injection gates directly communicate with the cavity for molding the bore wall portion. Therefore, when the projections formed at the injection gate are broken for removal after solidification of the molten resin, portions around the projections may also be removed together with the projections in a ripped manner. No ripping may occur if the projections are cut. However, in general, a cutting operation is more troublesome than a breaking operation by bending the projections. In the case of the method of Publication No. 2009-34970, in which the base is provided between the injection gate and the molded product, it is focused to the potential removal of a plated film caused when the projection formed at the gate is broken. Therefore, this method is not especially focused to prevent a phenomenon that causes a portion of the product to be ripped therefrom (hereinafter called “ripping phenomenon”). Although providing the base may contribute to prevent the product from being ripped to some extent, this publication gives no consideration to the configuration of the injection gate. Thus, if the injection gate has a circular cross section as is generally seen in this kind of injection gate, a stress may be dispersed when the projection is broken, and therefore, it may be possible that the ripping phenomenon may still occur over a wide range. In such a case, a portion of the molded product as well as the base may be ripped together with the gate projection. In the case of Publication No. 1-234220, the injection gate has a triangular shape, and therefore, a stress may be concentrated when the gate projection is broken. However, according to this publication, the gate projection is intended to be cut rather than being broken. In addition, because no base is provided, occurrence of the ripping phenomenon is unavoidable.

Further, in the case of Publication No. 2005-140061, the injection gate is positioned at the shaft cover portion. Because the shaft cover portion is a portion having a thickness smaller than the other portions of the throttle valve, for example, because of the presence of the throttle shaft and the limitation in thickness of the valve body. Therefore, resistance against flow of molten resin injected for forming the shaft cover portion is relatively large. In addition, because the injection gate is positioned at the top of the shaft cover portion, the molten resin injected from the injection gate directly impinges onto the throttle shaft before being branched to flow uniformly in opposite directions along the throttle shaft. Therefore, loss of pressure is large. Because of limitation in keeping the pressure within the cavity to a higher value during the injection molding process, the density of the resin material of the molded throttle valve may be lowered. If the density of the resin material is lowered, a degree of shrinkage of the molten resin during solidification may increase to lower the dimension accuracy of the throttle valve. Because the throttle valve is used for controlling the flow of intake air by increasing or decreasing the clearance between the disk-shaped valve body and the throttle body, lowering of the dimension accuracy of the throttle valve directly leads to an improper control of flow of the intake air.

In the case of Publication No. 2006-44047, because the injection gates directly communicate with the cavity for molding the bore wall portion, resistance against flow of the molten resin and loss of pressure of the molten resin may be large. Because of limitation in keeping the pressure within the cavity to a higher value during the injection molding process, the density of the resin material of the molded throttle body may be lowered. If the density of the resin material is lowered, a degree of shrinkage of the molten resin during solidification may increase to lower the dimension accuracy of the throttle body. As noted above, the throttle valve controls the flow of intake air by increasing or decreasing the clearance between the disk-shaped valve body and the throttle body, and lowering of the dimension accuracy of the throttle body directly leads to an improper control of flow of the intake air.

In the case of Publication No. 2009-34970, in which the base is provided between the injection gate and the body of the product, this publication relates to the method of manufacturing a shutter button of a digital camera and, is not intended to reduce resistance of flow or loss of pressure of the molten resin during the injection molding process. Therefore, the technique of this publication cannot be directly applied to a method of manufacturing a throttle valve, in which a throttle shaft is inserted into a molding die, and thereafter, molten resin is filled into a cavity around the throttle shaft. In order to avoid reduction of flow or loss of pressure during the molding process of the throttle valve, it may be possible to increase the capacity of the cavity in the method of Publication No. 2005-140061, so that resistance against flow of the molten resin may be reduced and an ability of keeping the pressure of the molten resin can be improved to increase the resin density of the throttle valve. However, this may lead to increase the size of a molding die, resulting in increase of the manufacturing cost, and therefore, this is not a practically applicable measure. In addition, the technique of this publication cannot be directly applied to a method of manufacturing a throttle body. For example, it is not possible to predict what portion of the throttle body is to be communicated with the injection gate via the base, or what configuration the base should have to correspond to the configuration of the base. In the case of Publication No. 2006-44047, the bore wall portion has a fixed inner diameter throughout the vertical length, and therefore, it is not possible to predict suitable communicating portions of the injection gates, for example, in the case that the throttle body has a small diameter portion and a large diameter portion formed in series with each other. Yet, even in the case that occurrence of the ripping phenomenon could be inhibited to some extent, an irregular surface may be remained at a portion where the projection is broken. Therefore, it is not possible to reduce resistance against flow of the intake air by simply providing a base on the bore wall portion.

Further, in the case of Publication No. 2009-34970, the side surface of the base extends perpendicular to the surface of the body of the product. When the base is cut by using a rotary cutting tool after solidification of the molten resin, a shearing force in a tangential direction of the rotary cutting tool may be applied to base. Because the side surface of the base extends perpendicular to the surface of the product body, the thickness of the base in a direction of application of the shearing force is small. Hence, the base may not have a sufficient strength against the shearing force applied during the cutting operation, and therefore, there is a possibility that the base is chipped. If the chipping action does not develop beyond the base, this may not cause a significant problem. However, it may be assumed that the chipping action develops to reach the product body (the valve body in the case of the throttle valve) beyond the base. If the valve body is chipped during the cutting operation of the base by the rotary cutting tool, flow of the intake air may not be properly controlled.

Therefore, there is a need in the art for a method of manufacturing a part, such as a throttle valve or a throttle body, of a throttle device, while minimizing potential breakage of the part, which may be caused when a projection formed at an injection gate is removed.

### SUMMARY OF THE INVENTION

A method of molding a part, such as throttle valve and a throttle body, of a throttle device includes resin-molding the part by an injection molding process using a molding die. The molding die has a mold cavity having a cavity portion for molding a base that may protrude from the resin part. The cavity portion for molding the base communicates with an injection gate, from which molten resin is injected into the mold cavity. The configuration of at least one of the base and the injection gate is determined such that a projection formed at the injection gate can be removed without substantially damaging the resin part.

### BRIEF DESCRIPTION OF THE DRAWINGS

FIG. 1 is a perspective view of a throttle device according to a first example;

FIG. 2 is a perspective view of a throttle valve of the throttle device;

FIG. 3 is sectional view of a molding die for molding the throttle valve according to the first example;

FIG. 4 is a cross sectional view of the molding die, where one of injection gates is viewed from its front side;

FIG. 5 is a schematic sectional view showing the flow of molten resin within a mold cavity;

FIG. 6 is a side view of the throttle valve with projections formed at the injection gates and remaining before being removed;

FIG. 7 is a schematic view showing the operation for removing one of bases of the throttle valve;

FIG. 8 is a schematic sectional view showing the flow of molten resin within a mold cavity according to a second example;

FIG. 9 is a perspective view of a throttle valve according to a third example;

FIG. 10 is an enlarged sectional view of a portion of a molding die according to a fourth example:

FIG. 11 is a perspective view of a throttle valve according to the fourth example;

FIG. 12 is a perspective view of a throttle device according to a fifth example;

FIG. 13 is a vertical sectional view of a molding die used for molding a throttle valve and a throttle body of the throttle device shown in FIG. 12;

FIG. 14 is a plan view of a bore wall portion of the throttle body immediately after being removed from the molding die;

FIG. 15 is a cross sectional view taken along line (15)-(15) in FIG. 14; and

FIG. 16 is a perspective view of a part of the bore wall portion around a base formed thereon and showing the state after bending and breaking a projection formed at an injection gate of the molding die.

### DETAILED DESCRIPTION OF THE INVENTION

Each of the additional features and teachings disclosed above and below may be utilized separately or in conjunction with other features and teachings to provide improved methods of manufacturing parts of throttle devices. Representative examples of the present invention, which examples utilize many of these additional features and teachings both separately and in conjunction with one another, will now be described in detail with reference to the attached drawings. This detailed description is merely intended to teach a person of skill in the art further details for practicing preferred aspects of the present teachings and is not intended to limit the scope of the invention. Only the claims define the scope of the claimed invention. Therefore, combinations of features and steps disclosed in the following detailed description may not be necessary to practice the invention in the broadest sense, and are instead taught merely to particularly describe representative examples of the invention. Moreover, various features of the representative examples and the dependent claims may be combined in ways that are not specifically enumerated in order to provide additional useful examples of the present teachings.

In one example, a method of manufacturing a throttle valve of a throttle device used for controlling a flow rate of intake air supplied to an internal combustion engine is taught. The throttle valve is rotatably supported by the throttle device and has a valve body and a throttle shaft defining a rotational axis. The valve body includes a cylindrical tubular shaft cover portion and a pair of semicircular disk portions extending from the shaft cover portion in opposite directions from each other. According to the example method, the method includes the steps of providing a molding die and injecting molten resin into the molding die after inserting the throttle shaft into the molding die. The molding die includes a mold cavity defined therein. The cavity includes a base cavity portion for molding a base on a surface of the shaft cover portion. The molding die further includes an injection gate, from which molten resin is injected. The injection gate communicates with the base cavity portion. A cross sectional configuration of the injection gate includes at least a corner portion. In this specification, the term “corner portion” is used to generally mean a non-linear configuration and may include a configuration bent at an acute angle or curved along a gently curved line. The molten resin is injected into the mold cavity through the injection gate and the base cavity portion after inserting the throttle shaft into the mold cavity.

According to this method, immediately after the injection molding process, a projection formed at the injection gate still remains on the surface of the shaft cover portion via the base. Therefore, the projection may preferably be removed. If the projection is removed by bending and breaking the same, it may be necessary to consider occurrence of ripping of a portion around the projection together with the projection. However, according to the example method, even in the case that a ripping phenomenon occurs, ripping occurs mainly at a portion of the base, and therefore, potential damage of the throttle valve can be avoided. In addition, because the cross sectional configuration of the injection gate includes at least a corner portion, a stress may concentrate in the corner portion. As a result, a range of occurrence of the ripping phenomenon can be minimized. Thus, the corner portion may serve as a stress concentrating portion. In this way, it is possible to limit the range of occurrence of the ripping phenomenon to a portion of the base, and therefore, it is possible to reliably prevent the valve body from being damaged. If the projection can be removed without causing any problem even by bending and breaking the same, the productivity of valve body can be improved because bending and breading the projection can be easily made in comparison with cutting the projection.

Although a cross sectional area of the injection gate may be the same as a cross sectional area of a runner that supplies molten resin into the injection gate, the cross sectional area of the injection gate may preferably be smaller than that of the runner. In other words, the injection gate may be thinner than the runner. If the cross sectional area of the injection gate is smaller than that of the runner, an end portion of the runner may be tapered toward the injection gate. Therefore, a stress or a bending force applied during the removing operation can be reduced, so that the removing operation of the projection can be easily performed.

Although the cross sectional configuration is not limited to a particular configuration as long as it has a corner portion, the cross sectional configuration may be a bell-like configuration. In this specification, the term “bell-like configuration” is used to mean a rectangular configuration with one side curved to have a circular arc-shape. If the corner portion is bent at an acute angle, a possibility may exist that a stress is concentrated more than necessary to increase influence of a ripping phenomenon. However, if the corner portion is a curved surface (apex) of the bell-like shape and a stress is concentrated in such a corner portion, it is possible to prevent the stress from being concentrated more than necessary. In addition, the bell-like shape can provide a smooth flow of molten resin in comparison with a configuration having a bent portion with an acute angle, and therefore, it is advantageous from a viewpoint of reducing flow resistance and loss of pressure.

Only one injection gate and only one base may be provided. However, the base may include a first base and a second base, and the injection gate may include a first injection gate and a second injection gate. The base cavity portion includes a first base cavity portion and a second base cavity portion for molding the first base and the second base, respectively. The first injection gate and the first base cavity portion may be disposed on a first side. The second injection gate and the second base cavity portion may be disposed on a second side opposite to the first side with respect to the throttle shaft in a direction perpendicular to an axial direction of the throttle shaft. The mold cavity may further includes a first cover cavity portion and a second cover cavity portion for molding the shaft cover portion, and a first disk cavity portion and a second disk cavity portion for molding the pair of semicircular disk-shaped portions. The first base cavity portion and the first injection gate may be positioned to be opposed to a top portion of the first cover cavity portion. The second base cavity portion and the second injection gate may be positioned to be opposed to a top portion of the second cover cavity portion. In this case, the first and second injection gates may preferably be offset from each other in opposite directions along extending directions of the first and second disk cavity portions, with respect to a first central line passing through an axial center of the throttle shaft and extending perpendicular to the extending directions of the first and second disk cavity portions.

In the case that molten resin is injected into the cover cavity portions, the molten resin is necessary to reach to the opposite side by flowing around the throttle shaft that has been inserted. Therefore, this may lead to loss of pressure of the molten resin. In contrast, if the molten resin is injected into the cover cavity portions from opposite sides with respect to the throttle shaft, the injected molten resin is not necessary to reach the opposite side of the throttle shaft. In this case, because the first and second injection gates are opposed to the first and second cover cavity portions, respectively, it is possible to allow the molten resin to flow on opposite sides in the direction parallel to the extending directions of the semicircular disk-shaped portions. As a result, it is possible to successfully mold the shaft cover portion. In addition, if the first and second injection gates are offset from the central line, an amount of the molten resin flowing in the offset direction at each of the cover cavity portions becomes larger than an amount of the molten resin flowing in an opposite direction. Therefore, resistance against flow of the molten resin in the offset direction can be decreased and it is possible to prevent the molten resin from directly impinging on the throttle shaft after being injected from the injection gates. Therefore, loss of pressure of the molten resin can be also reduced. Hence, it is possible to keep the pressure within the mold cavity at a higher pressure during a longer period of time than available in the known art. As a result, it is possible to improve the density of the resin of the valve body, reduce the degree of shrinkage after solidification of the resin, and improve the dimensional accuracy of the valve body. Although the flow resistance in one direction may be reduced even in the case having only one injection gate, providing the first and second injection gates offset in opposite directions can reduce the resistance of flow in both directions. Therefore, it is possible to improve the resin density through the entire valve body.

Preferably, the first base cavity extends from the top of the first cover cavity portion in an offsetting direction of the first injection gate, and the second base cavity extends from the top of the second cover cavity portion in an offsetting direction of the second injection gate. With this arrangement, the presence of the first and second base cavities can enlarge the widths of the flow paths directly below the respective first and second injection gates, and therefore, it is possible to further reduce the resistance against flow of the molten resin. In addition, because the width of the flow path in the extending direction of each base cavity is different from the width of the flow path in the opposite direction. Therefore, the flow rate in the opposite direction can be effectively reduced.

The cross sectional configuration of the base is not necessary to correspond to the cross sectional configuration of the corresponding injection gate. However, the cross sectional configuration of the base may be similar to or identical with the cross sectional configuration of the injection gate. With this setting, the molten resin injected from the injection gate can smoothly flow through the corresponding base cavity, so that the flow resistance and the pressure loss can be further reduced.

Although the first and second disk cavity portions may be positioned on the same axis (or on the same plane), it may be preferable that the first and second disk cavity portions are offset from each other in opposite directions with respect to a second central line passing through the axial center of the throttle shaft in parallel to the extending directions of the first and second disc cavity portions. In such a case, the first disk cavity portion and the first injection gate may be offset toward each other, and similarly, the second disk cavity portion and the second injection gate may be offset toward each other. With this arrangement, it is possible to increase widths of portions of the flow paths positioned directly below the injection gates and oriented in directions along which the molten resin mainly flows. Therefore, it is possible to further reduce the flow resistance and the pressure loss.

Further, although the throttle shaft may have a diameter that is uniform throughout its length, a diameter of a portion of the throttle shaft opposed to the injection gate(s) may preferably be smaller than a diameter of the remaining portion of the throttle shaft. With this arrangement, a thickness of the shaft cover portion at a position opposed to the injection gate(s) can be increased, and therefore, a portion of the flow path positioned directly below the injection gate(s) can be increased to further decrease the flow resistance and the pressure loss. In addition, because of increase of thickness of the shaft cove portion, the strength of the shaft cover portion can be increased. This enables reduction of the thickness of the semicircular disk portions, and therefore, it is possible to decrease the available open area of the flow path for the intake air in a fully opened position of the throttle valve.

After solidification of the molten resin, the projection(s) molded at the injection gate(s) may preferably be removed by bending and breaking the same. Such a bending and broking operation can be easily made than a cutting operation.

The base or each of the bases may have a side surface inclined such that the cross sectional area of the base increases from the side of the injection gate toward the side of the shaft cover portion. The base may be cut by a rotary cutting tool after solidification of the molten resin. Such a cutting operation of the base may be made as a finishing operation after bending and breaking the projection. By cutting the base, the protruding amount of the base can be reduced and a flat cutting surface may be formed, so that flow of the intake air may not be substantially influenced by the base. In the case that the base is cut by using a rotary cutting tool, a shearing force may be applied to the base in a tangential direction. However, because the thickness of the base in a direction of application of the shearing force is large due to the configuration of the side surface, it is possible to effectively prevent potential damage to the base during the cutting operation.

If the base is removed only by using a rotary cutting tool, the configurations of the injection gate and the corresponding base are not necessary to be limited to particular configurations. Thus, it is not necessary that the injection gate or the base has a cross sectional configuration including a corner portion but may have a circular cross sectional configuration. Thus, in such a case, it is only necessary that the base has a side surface inclined such that the cross sectional area of the base increases from the side of the injection gate toward the side of the shaft cover portion.

In another example, a method of manufacturing a throttle body of a throttle device used for controlling a flow rate of intake air supplied to an internal combustion engine is taught. The throttle body includes a cylindrical tubular bore wall portion defining an intake air passage therein. According to the example method, the method includes the steps of providing a molding die and injecting molten resin into the molding die. The molding die includes a mold cavity defined therein. The mold cavity includes a base cavity portion for molding a base projecting from an inner circumferential surface of the bore wall portion. The molding die further includes an injection gate, from which, molten resin is injected. The injection gate communicates with the base cavity portion. Therefore, molten resin is injected into the mold cavity through the injection gate and the base cavity portion. A cross sectional configuration of the injection gate includes at least one corner portion. As explained in connection with the above example method of manufacturing the throttle valve, the term “corner portion” is used to generally mean a non-linear configuration and may include one bent at an acute angle or curved along a gently curved line.

According to this method, immediately after the injection molding process, a projection formed at the injection gate still remains on the inner circumferential surface of the bore wall portion to extend from the base. Therefore, it may be necessary to remove the projection. If the projection is removed by a bending and breaking operation, it may be necessary to consider occurrence of ripping of a portion around the projection together with the projection. However, according to the example method, even in the case that a ripping phenomenon occurs, ripping may occur mainly at a portion of the base, and therefore, potential damage to the bore wall portion of the throttle body can be effectively avoided. In addition, because the cross sectional configuration of the injection gate includes at least a corner portion, a stress may concentrate in the corner portion. As a result, a range of occurrence of the ripping phenomenon can be minimized. Thus, also in this example method, the corner portion may serve as a stress concentrating portion. In this way, it is possible to limit the range of occurrence of the ripping phenomenon to a portion of the base, and therefore, it is possible to reliably prevent the throttle body from being damaged. If the projection can be removed without causing any problem by bending and breaking the same, the productivity of the throttle body can be improved because bending and breading the projection can be easily made in comparison with cutting the projection.

Although a cross sectional area of the injection gate may be the same as a cross sectional area of a runner that supplies molten resin into the injection gate, the cross sectional area of the injection gate may preferably be smaller than that of the runner. In other words, the injection gate may be thinner than the runner. If the cross sectional area of the injection gate is smaller than that of the runner, an end portion of the runner may be tapered toward the injection gate. Therefore, a stress or a bending force applied during the removing operation can be reduced, so that the removing operation of the projection can be easily performed. It is also possible to minimize the range of occurrence of the ripping phenomenon.

Although the cross sectional configuration of the gate is not necessary to correspond to the cross sectional configuration of the injection gate, the cross sectional configuration of the base may be similar to or identical with the cross sectional configuration of the injection gate. The ripping phenomenon may develop from the projection. Therefore, if the configuration of the base is the same as that of the injection gate, the base may not have an unnecessarily large size. In this case, the base is formed along the cross sectional configuration of the injection gate, and therefore, it is possible to efficiently prevent potential damage to the throttle body while the base has a minimum size. By minimizing the external diameter of the base, it is possible to reduce resistance against flow of the intake air. Further, the molten resin injected from the injection gate can smoothly flow without causing stagnation at the cavity portion for forming the base. Therefore, it is possible to reduce the flow resistance and the pressure loss of the molten resin during the injection molding process. For this reason, it is possible to keep the pressure within the mold cavity at a higher pressure during a longer period of time. As a result, it is possible to improve the density of the resin of the throttle body, reduce the degree of shrinkage after solidification of the resin, and improve the dimensional accuracy of the throttle body.

Although the cross sectional configuration of the injection gate is not limited as long as it has a corner portion, the cross sectional configuration may be a bell-like configuration. If the corner portion is bent at an acute angle, a possibility may exist that a stress is concentrated more than necessary to increase influence of a ripping phenomenon. However, if the corner portion is a curved surface (apex) of the bell-like shape and a stress is concentrated in such a corner portion, it is possible to prevent the stress from being concentrated more than necessary. In addition, the bell-like shape can provide a smooth flow of molten resin in comparison with a configuration having a bent portion with an acute angle, and therefore, it is advantageous from a viewpoint of reducing flow resistance and loss of pressure.

Although the side surface of the base may extend perpendicular to the bore wall portion, the side surface may preferably be inclined such that a cross sectional area of the base increases from the side of the injection gate toward the side of the bore wall portion. The molten resin injected from the injection gate may flow into the cavity for molding the base and may flow further into the cavity for molding the bore wall portion such that the molten resin disperses into the cavity for molding the bore wall portion. Because the side surface of the cavity for molding the base is inclined, the molten resin can easily flow to be dispersed. Therefore, it is possible to further reduce the flow resistance and the pressure loss. As a result, it is possible to keep the pressure within the mold cavity at a higher pressure during a longer period of time, improve the density of the resin of the throttle body, and improve the dimensional accuracy of the throttle body.

In the case that the bore wall portion includes a small diameter portion and a large diameter portion having different inner diameters from each other and formed in series with each other via a stepped portion having an inclined surface, it may be preferable that the base projects from the stepped portion. In such a case the injection gate may be opposed to the stepped portion. It may be possible to form the base on the small diameter portion or the large diameter portion in place of or in addition to the stepped portion. However, if the base is formed to project from the small diameter portion or the large diameter portion, a possibility may exist that the base prevents flow of intake air in some cases. If the base is formed to project from the inclined surface of the stepped portion that connects between the small diameter portion and the large diameter portion, it is possible to minimize the influence of the base on the flow of intake air.

Preferably, the base extends from the small diameter portion to the large diameter portion, and the base has an inner circumferential surface extending in continuity with an inner circumferential surface of the small diameter portion. Because the thickness of the large diameter portion is smaller than that of the small diameter portion, the molten resin may not flow smoothly through a cavity portion of the molding die for forming the large diameter portion in comparison with the a cavity portion of the molding die for forming the small diameter portion. Providing the base to extend from the small diameter portion to the large diameter portion can increase a width of a portion of a flow path that is positioned directly below the injection gate and oriented toward the side of the large diameter portion. Therefore, the molten resin injected from the injection gate can flow smoothly also toward the side of the large diameter portion. As a result, it is possible to reduce the flow resistance and the pressure loss of the molten resin that flows toward the side of the large diameter portion. The molten resin can flow naturally smoothly toward the side of the small diameter portion. In addition, because the inner circumferential surface of the base extends in continuity with the inner circumferential surface of the small diameter portion, the intake air may further smoothly flow through the stepped portion.

Although the inner circumferential surface of the base may be parallel to the inner circumferential surfaces of the large diameter portion and the small diameter portion, the base may preferably have a thickness decreasing from the side of the small diameter portion toward the side of the large diameter portion, so that the inner circumferential surface of the base is inclined. Further, the inner circumferential surface of the base may preferably be configured as an arc-shaped surface having a same radius of curvature as that of the bore wall portion. With this arrangement, the molten resin can more smoothly flow toward the side of the large diameter portion, and the flow resistance against flow of the intake air can be further reduced. In particular, if the thickness of the base gradually decreases from the side of the small diameter portion toward the side of the large diameter portion, it is possible to prevent increase of the flow resistance even in the case that an irregular surface is remained at a portion where the projection is bent and removed. Protruding portions of the irregular surface do not extend radially inwardly beyond the small diameter portion.

After solidification of the molten resin, the projection formed at the injection gate may preferably be removed by bending and breaking the projection. The operation for bending and breaking the projection can be more effectively made than the operation for cutting the projection, and therefore, the productivity of the throttle body can be improved.

If the projection is removed by bending and breaking the projection, it may be preferable that at least one corner portion of the injection gate is positioned on the rear side (opposite side) with respect to a direction for bending and breaking the projection. In particular, if the injection gate has only one corner portion, it may be preferable that the projection is broken by bending the projection from the side opposite to the corner portion toward the side of the corner portion. If the injection gate has a plurality of corner portions, one or more of the corner portions may be positioned on the rear side with respect to the bending direction. In such a case, a stress may concentrate certainly in a portion of the projection positioned at the rear end with respect to the bending direction. Therefore, occurrence of the ripping phenomenon can be effectively prevented.

### First Example

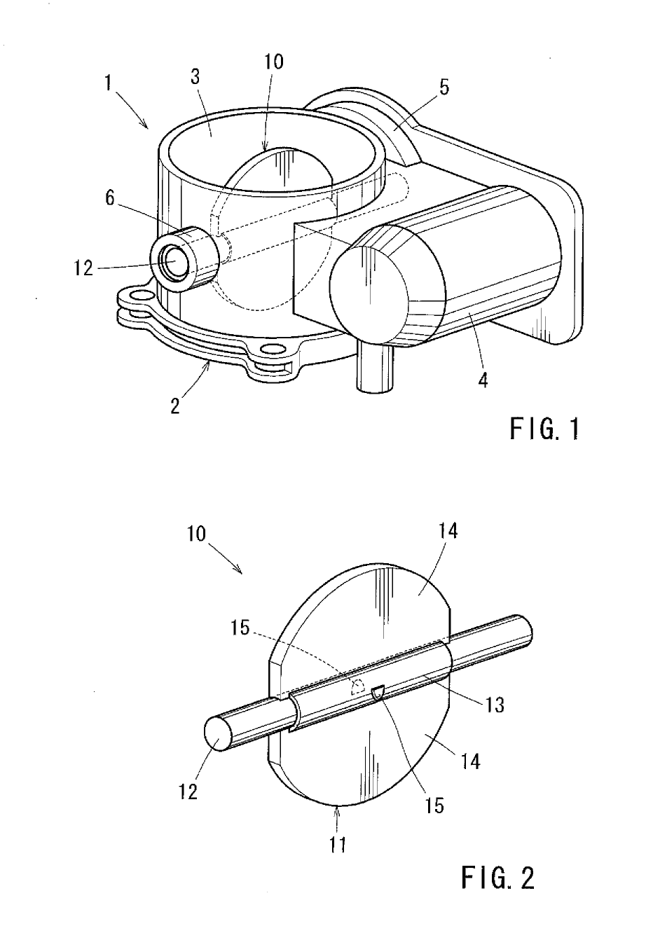

Referring to FIG. 1, a throttle valve 10 manufactured by a first representative method is shown. The throttle valve 10 is mounted to a throttle device 1 so as to be rotatable about an axis. The throttle device 1 may be mounted to a vehicle, such as an automobile, for controlling a flow rate of intake air supplied to cylinders of an internal combustion engine (not shown). The throttle device 1 includes a throttle body 2 made of resin. The throttle body 2 has a cylindrical tubular bore wall portion 3, a motor housing portion 4 and a gear box portion 5. An internal space defined within the bore wall portion 3 serves as an intake air passage for the flow of the intake air. The throttle valve 10 is disposed within the bore wall portion 3 so as to be rotatable both in a normal direction and a reverse direction. Opposite ends in the axial direction of the throttle valve 10 are rotatably supported by respective bearings 6 that are mounted to the bore wall portion 3 at positions opposite to each other. The rotational position of the throttle valve 10 can be controlled according to a stepping amount of an accelerator pedal (not shown). According to the rotation of the throttle valve 10, a clearance between the outer peripheral edge of the throttle valve 10 and the inner wall surface of the bore wall portion 3 changes, so that a flow rate of intake air supplied to the internal combustion engine can be controlled. FIG. 1 shows a fully opened position of the throttle valve 10. In a fully closed poison, the throttle valve 10 extends substantially perpendicular to the direction of flow of intake air (substantially horizontal, as viewed in FIG. 1). A motor (not shown) is disposed within the motor housing 4 and serves as a drive device for rotatably driving the throttle valve 10. A gear mechanism (not shown) is disposed within the gear box portion 5 for transmitting the driving force of the motor to the throttle valve 10.

As shown in FIG. 2, the throttle valve 10 has a substantially circular disk-shaped valve body 11 made of resin and a substantially rod-like throttle shaft 12 made of metal. The throttle shaft 12 serves as a center of rotation of the throttle valve 10. The throttle shaft 12 extends through the central portion of the valve body 11 in a diametrical direction within a plane of the disk-shape of the valve body 11. Opposite ends of the throttle shaft 12 are supported by the bearings 6 of the bore wall portion 3. The valve body 11 has a cylindrical tubular shaft cover portion 13 and a pair of semicircular disk-shaped portions 14 formed integrally with the shaft cover portion 13. The shaft cover portion 13 is configured to cover the throttle shaft 12. The pair of semicircular disk-shaped portions 14 are disposed on opposite sides of the shaft cover portion 13 and extend in opposite directions to each other. A pair of bases 15 each having a bell-like cross sectional configuration are integrally formed on the shaft cover portion 13 and protrude from the outer circumferential surface of the shaft cover portion 13. With respect to the axial direction of the shaft cover portion 13, the pair of bases 15 are positioned substantially centrally of the shaft cover portion 13. With respect to the circumferential direction of the shaft cover portion 13, the pair of bases 15 are positioned at apexes of semi-cylindrical outer surfaces of the shaft cover portion 13. The bases 15 have lengths extending in opposite directions, which correspond to the extending directions of the semicircular disk-shaped portions 14 (i.e., substantially vertical direction as viewed in FIG. 2). Although not shown in the drawings, a plurality of reinforcing ribs may be integrally formed on the surfaces of the semicircular disk-shaped portions 14 so as to extend perpendicular to the axial direction of the throttle shaft 12 and to be spaced equally from each other.

The throttle body 2 and the valve body 11 may be molded by an injection molding process of a heat-resistant thermoplastic resin, such as polyphenylene sulfide (PPS), polyamide (PA), polypropylene (PP) and polyetherimide (PEI).

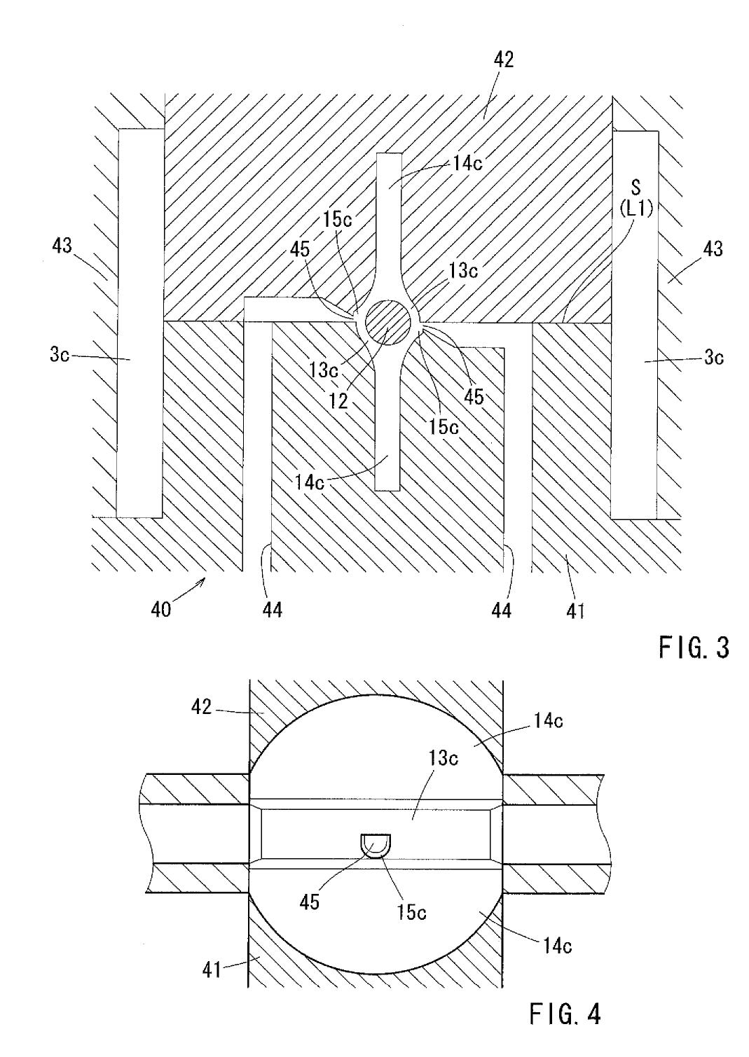

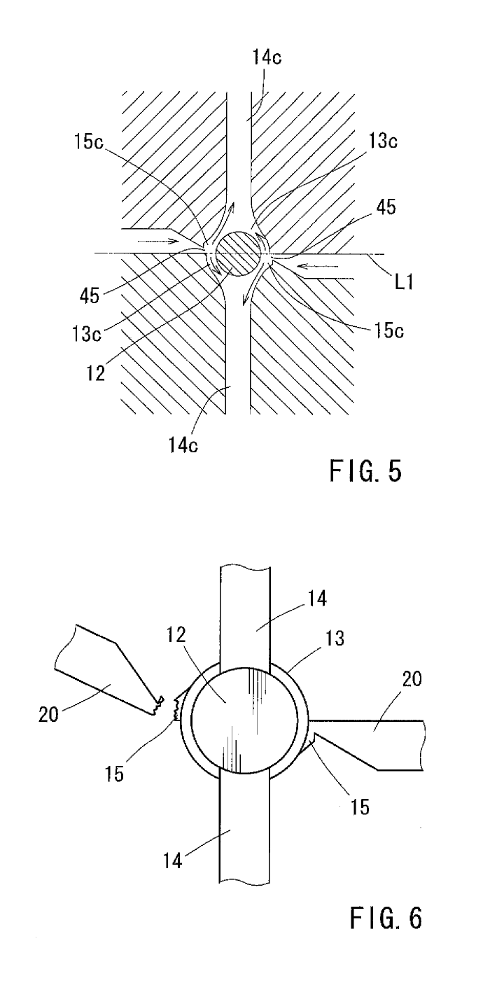

A representative method of manufacturing the throttle valve 10 will now be described with reference to FIGS. 3 to 7. Basically, according to the representative manufacturing method, the valve body 11 is injection-molded in the state that the throttle shaft 12 is inserted into a molding die 40 that defines a mold cavity having a predetermined configuration. The molding die 40 generally includes a stationary die part 41, a movable die part 42 and slide cores 43, which cooperate to define the mold cavity when the die part 42 and the slide cores 43 are moved to close the molding die 40. More specifically, cavities 13c for molding the shaft cover portion 13 and cavities 14c for molding the semicircular disk-shaped portions 14 are defined in the stationary die part 41 and the movable die part 42, respectively, in series with each other. The cavities 13c jointly form a cavity for the shaft molding portion 13. Therefore, when the movable die part 42 is moved to contact the stationary die part 41 for closing the molding die 40, a cavity central line L1 (see FIG. 5) is positioned within a plane S where the stationary die part 41 and the movable die part 42 contact with each other. Here, the cavity central line L1 passes through the axial center of the throttle shaft 12 (i.e., the axial center of the cavity (formed by the cavities 13c) defining the shaft cover portion 13) and extends perpendicular to the extending direction of the cavities 14c defining the semicircular disk-shaped portions 14. At positions corresponds to apexes of the cavities 13c or the shaft cover portion 13, cavities 15c for forming the respective bases 15 are formed in the stationary die part 41 and the movable die part 42.

Two runners 44 serving as flow passages of the molten resin are formed in the stationary die part 41 at positions on the opposite sides of the cavities 14c for the semicircular disk-shaped portions 14. The runners 44 communicate with the respective cavities 15c for the bases 15 via injection gates 45 at positions corresponds to the apexes of the semi-cylindrical surfaces of the cavities 13c or the shaft cover portion 13. Therefore, two injection gates 45 are provided at positions opposed to each other with respect to the throttle shaft 12 in a direction (right and left direction as viewed in FIG. 3) perpendicular to the axial direction of the throttle shaft 12 (more specifically, the shaft cover portion 13). The direction of arrangement of the injection gates 45 is perpendicular to the extending direction of the cavities 14c or the semicircular disk-shaped portions 14. The front portions of the runners 44 are tapered toward the respective injection gates 45, so that the cross sectional area of each of the injections gates 45 is smaller than the cross sectional area of each of the runners 44. A cavity 3c is also defined in the molding die 42 for molding the bore wall portion 3. Molten resin can be injected into the cavity 3c via at least one injection gate that is different from the injection gates 45.

One of the injection gates 45 and the corresponding one of the cavities 15c for forming the bases 15 (those positioned on the right side as viewed in FIG. 3 in this example) are formed in the stationary die part 41, and the other injection gate 45 and the corresponding cavity 15c (those positioned on the left side as viewed in FIG. 3 in this example) are formed in the movable die part 42. Therefore, the injection gate 45 and the cavity 15c positioned on one side are formed directly below the contact plane S between the stationary die part 41 and the movable die part 42, while the injection gate 45 and the cavity 15c positioned on the other side are formed directly above the contact plane S. Thus, the injection gate 45 and the cavity 15c positioned on one side and the injection gate and the cavity 15c positioned on the other side are disposed on opposite sides with respect to the cavity central line L1 passing through the axial center of the throttle shaft 12 (or the cavities 13c for the shaft cover portion 13) and are offset from each other in the extending direction (vertical direction in this example) of the cavities 14c for the semicircular disk-shaped portions 14c. The cavities 15c for the bases 15 are formed to extend from the apexes of the cavities 13c for the shaft cover portion 13 (i.e., from the cavity central line L1) toward the respective injection gates 45. As shown in FIG. 4, the injections gates 45 have the same cross sectional configuration (a bell-like cross sectional configuration in this example). The cavities 15c for the bases 15 also have the same cross sectional configuration (a bell-like cross sectional configuration similar to the bell-like cross sectional configuration of the injection gates 45 in this example). In addition, a side surface of each cavity 15c is inclined such that the cross sectional area of each cavity 15c increases from the side of the corresponding injection gate 45 toward the corresponding cavity 13c for the shaft cover portion 13. In other words, the side surface of each base 15 is inclined such that the cross sectional area of each base 15 increases toward the shaft cover portion 13.

Next, the injection molding process will be described. First, the throttle shaft 12 is inserted into the molding die 40 and is then fixed in position at the central portion of the cavity formed by the cavities 13c for the shaft cover portion 13. After that, the movable die part 42 is moved toward the stationary die part 41 for closing the molding die 40, so that the mold cavity is defined within the molding die 40. Thereafter, molten resin is injected into the mold cavity through the runners 44 and the respective injection gates 45 that are opposed to the cavities 13c. Then, the molten resin flows through the cavities 13c in such a manner that the flow of the molten resin is divided into different streams as shown in FIG. 5. Because the cavities 15c for the bases 15 are provided and because the injection gate 45 and the cavity 15c positioned on one side with respect to the cavity central line L1 and the injection gate 45 and the cavity 15c positioned on the other side are offset from each other, the molten resin flows through the cavities 13c at different flow rates depending on positions within the cavities 13c. More specifically, the molten resin injected from the injection gate 45 positioned on one side with respect to the cavity central line L1 (on the lower side in this example) and positioned on the right side as viewed in FIG. 5 may impinge on a portion of the throttle shaft 12 positioned on the lower side of the cavity central line L1. Therefore, the molten resin tends to flow downward. In addition, the flow area is enlarged due to the presence of the cavity 15c for the base 15. As a result, the molten resin flows mainly downward through the corresponding cavity 13c for the shaft cover portion 13. Although the molten resin may also flow upward, the flow rate is small in comparison with that of the downward flow of the molten resin. On the other hand, the molten resin injected from the injection gate 45 positioned on the other side with respect to the cavity central line L1 (on the upper side in this example) and positioned on the left side as viewed in FIG. 5 may impinge on a portion of the throttle shaft 12 positioned on the upper side of the cavity central line L1. Therefore, the molten resin tends to flow upward. In addition, the flow area is enlarged due to the presence of the cavity 15c for the base 15. As a result, the molten resin flows mainly upward through the corresponding cavity 13c for the shaft cover portion 13. Although the molten resin may also flow downward, the flow rate is small in comparison with that of the upward flow of the molten resin.

For the above reasons, the molten resin injected from the injection gate 45 positioned on the right side may be primarily filled into the cavity 14 for one of the semicircular disk-shaped portions 14c (one positioned on the lower side in this example), while the molten resin injected from the injection gate 45 positioned on the left side may be primarily filled, into the cavity 14 for the other semicircular disk-shaped portion 14c (positioned on the left side in this example). This may lead to reduce the resistance against flow of the molten resin and the loss of pressure in comparison with the case where the molten resin flows uniformly in the upward and downward directions. In addition, each of the cavities 15c or the bases 15 has the bell-shaped configuration and each of the injection gates 45 also has the ball-shaped configuration similar to that of the cavities 15c, and therefore, the flow resistance and the pressure loss can be further reduced. As a result, it is possible to maintain the resin pressure within the mold cavity at a high, pressure for a long time, so that the resin density can be improved and the dimension accuracy of the valve body 11 can be improved.

After solidification of the molten resin, a molded product is removed from the molding die 40, so that the throttle valve 11 having the throttle shaft 12 inserted therein can be obtained as the molded product. However, the molded product still has projections 20 formed at the injection gates 45 and the runners 44 communicating with the respective injection gates 45. Therefore, the projections 20 are necessary to be removed. For the removal of the projections 20, the projections 20 are bent so as to be broken. At the time of removing the projections 20, it may be possible that portions around the projections 20 are ripped together with the projections 20. Thus the ripping phenomenon may occur. However, according to the present example, the portions of the projections 20 formed at the injection gates 45 have the bell-like cross sectional configuration, and therefore, a stress applied to each projection 20 may be concentrated in an apex of the bell-like shape of the cross section of each injection gate 45. Therefore, the ripping phenomenon may affect to only a limited extent. In addition, because the cross sectional area of the injection gates 45 is smaller than the cross sectional area of the runners 44, a smaller stress may be concentrated in each injection gate 45. Further, even in the case that the ripping phenomenon occurs, only the bases 15 may be chipped at the worst, because the projections 20 are formed on the bases 15. Therefore, it is possible to reliably prevent the valve body 11 from being broken or damaged.

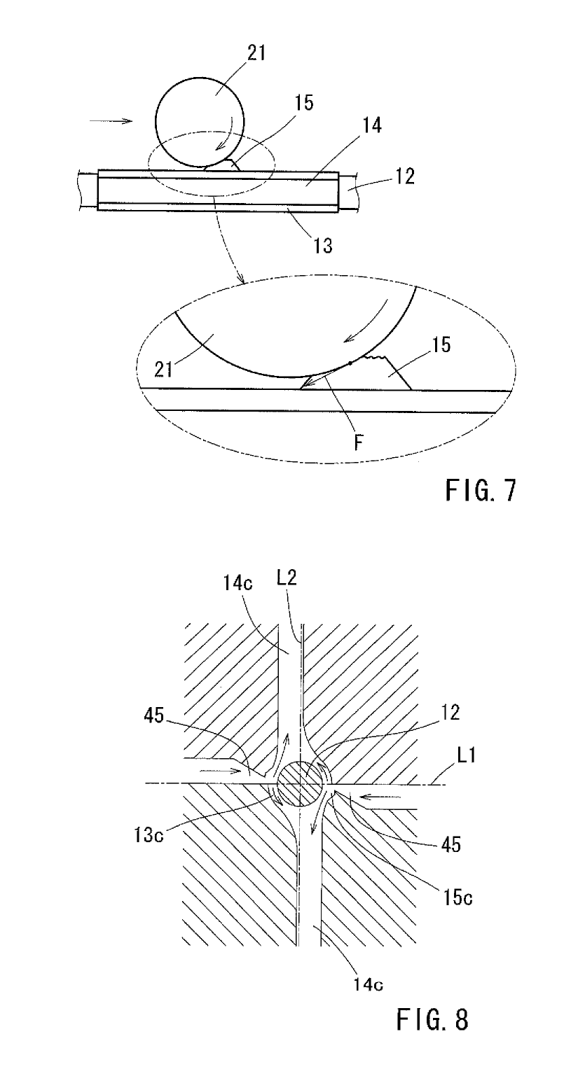

After removing the projections 20, the throttle valve 10 can be assembled with the throttle device 1 for use. However, even after removing the projections 20, the bases 15 may still protrude from the throttle valve 10 and the broken upper surfaces of the bases 15 may not be smooth. Therefore, it may be possible that the bases 15 affect the flow of intake air. For this reason, it may be preferable that the bases 15 are finished by being cut. For cutting the bases 15, a rotary cutting tool that can slide as it rotates may preferably be used. As a representative example of this kind of rotary cutting tool, an end mill 21 shown in FIG. 7 can be used. As shown in FIG. 7, during the rotary cutting operation of the base 15 by the end mill 21, a shearing force F may be applied to the base 15 in a tangential direction of the end mill 21. Therefore, it may be possible that the shearing force F breaks the base 15. However, in this example, the side surface of the base 15 is inclined such that the cross sectional area of the base 15 increases from the side of the projection 20 toward the shaft cover portion 13. In other words, the base 15 is enlarged toward the shaft cover portion 13. Therefore, the thickness of the base 15 is large in the direction of application of the shearing force F. As a result, the base 15 is hard to be broken, and hence, the influence of the shearing force F is hard to reach the shaft cover portion 13.

### Possible Modifications of First Example

Possible modifications of the above representative example will now be described as second to fourth examples with reference to FIGS. 8 to 11, in which like members are given the same reference signs as the first example and the description of these members will not be repeated.

### Second Example

In the case of the first example, the semicircular disk-shaped portions 14 are formed within the same plane. According to the second example shown in FIG. 8, the semicircular disk-shaped portions 14 are offset from each other in opposite directions with respect to a central line L2 that passes through the axial center of the throttle shaft 12 and extends parallel to the extending directions of the semicircular disk-shaped portions 14 (vertical direction in this example). In this case, the semicircular disk-shaped portions 14 are preferably offset toward the side of the respective bases 15. In other words, the cavities 14c of the mold cavity of the molding die 40 are offset in directions towards the corresponding injection gates 45. With this arrangement, the widths of the flow paths defined by the cavities 13c for the shaft cover portions 13 at positions opposing to the respective injection gates 45 become larger than that in the first example, and therefore, it is possible to further decrease the flow resistance and the loss of pressure.

### Third Example

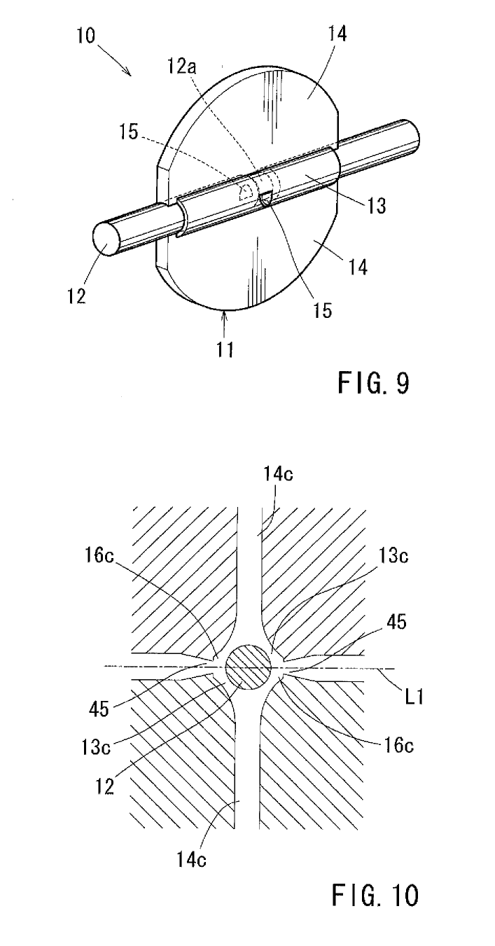

in the above first example, the throttle shaft 12 having a uniform diameter throughout the length between its opposite ends is inserted into the mold cavity. However, according to a third example shown in FIG. 9, the throttle shaft 12 has a smaller diameter portion 12a at a central position with respect to the axial direction, i.e., a position opposing to the injection gates 45. With this configuration, the widths of the flow paths defined by the cavities 13c for the shaft cover portions 13 at a position corresponding to the smaller diameter portion 12a opposed to the injection gates 45 become larger than that in the first example. Therefore, it is possible to further decrease the flow resistance and the loss of pressure.

### Fourth Example

The first example was focused to improve the density of the resin of the valve body 11 on the condition that the projections 20 are bent to be broken after the molding process. If the prevention of breakage of the bases 15 during the cutting operation rather than the improvement of the resin density is intended, the configurations of the injection gates and the bases may not be necessary to be limited to particular configurations as long as the side surfaces of the gates are configured as inclined surfaces enlarged from the sides of the injection gates toward the side of the shaft cover portion. For example, a fourth example may correspond to Japanese Laid-Open Patent Publication No. 2005-140061 referred to as the background art except that this publication does not include bases that have inclined surfaces and have a cross sectional area increasing toward the shaft cover portion.

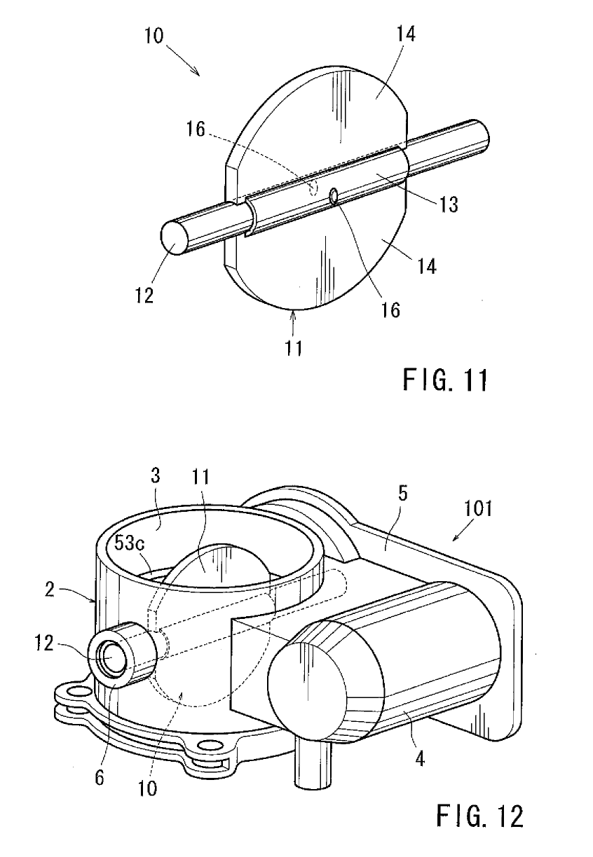

As shown in FIG. 11, according to the fourth example, circular bases 16 are formed on the shaft cover portion 13. More specifically, as shown in. FIG. 10, the injection gates 45 communicate with the top portions of cavities 13c for the shaft cover portion 13 via the bases 16 at positions opposed to each other in the axial direction of the central line L1, and the injections gates 45 have the same axis (i.e., the central line L1). Each of the injection gates 45 has a circular cross section similar to a circular cross section of the bases 16. Although the bases 16 have the same axis as the central line L1, the side surfaces of the bases 16 are configured as inclined surfaces, so that the cross sectional area of each base 16 increases from the side of the corresponding gate 45 toward the side of the corresponding cavity 13c for the shaft cover portion 13. With this arrangement, when the bases 16 are cut by a rotary cutting tool (not shown) after solidification of the molten resin, the bases 16 may not be easily broken. Thus, because the side surface of each bases 16 is inclined to increase the cross sectional area toward the shaft cover portion 13, each base 16 has a large thickness in a direction of application of a shearing force F as in the case of FIG. 7 of the first example.

### Other Possible Modifications of First to Fourth Examples

According to the above examples, the throttle valve 10 and the throttle body 2 are molded separately from each other by injecting molten resin from different injection gates. However, the same runners 44 can supply molten resin into the cavity for molding the valve body 11 and also into the cavity for molding the throttle body 2, so that the throttle valve 10 and the throttle body 2 can be simultaneously molded. If the bases are cut by using a rotary cutting tool, the projections (formed at the gates and portions of the runners connected thereto) may not be necessary to be broken by bending. Thus, the projections can be removed together with the bases by the cutting operation of the bases. Other than an end mill, a grinding tool or the like can be also used as the rotary cutting tool.

In addition, the cross sectional configuration of the injection gates is not limited to the bell-shaped configuration as long as it is a non-circular configuration including at least one corner portion where a stress may be concentrated. For example, the cross sectional configuration may be a polygonal configuration, such as a triangular configuration and a rectangular configuration, a sectorial configuration or an oval configuration. The cross sectional area of the gates may be different or same as the cross sectional area of the corresponding runners. It is not necessary that the bases are offset from each other as long as at least the injection gates are offset from each other. Further, the cross sectional configuration of the gates may be different from the cross sectional configuration of the corresponding bases.

### Fifth Example

A fifth example will now be described with reference to FIGS. 12 to 16. Referring to FIG. 11, there is shown a throttle device 101 according to this example. This throttle device 101 is a modification of the throttle device 1 shown in FIG. 1 of the first example. Therefore, in FIGS. 12 to 16, like members are given the same reference signs as the first example and the description of these members will not be repeated. According to this example, the throttle body 2 is also molded by an injection molding process. Similar to the first example, the throttle shaft 10 has the disk-shaped valve body 11 made of resin and the throttle shaft 12 made of metal. The valve body 11 is molded with the throttle shaft 12 inserted into a mold cavity of a molding die that will be explained later.

Also in this example, both of the throttle body 2 and the valve body 11 may be molded by an injection molding process of a heat-resistant thermoplastic resin, such as polyphenylene sulfide (PPS), polyamide (PA), polypropylene (PP) and polyetherimide (PEI).

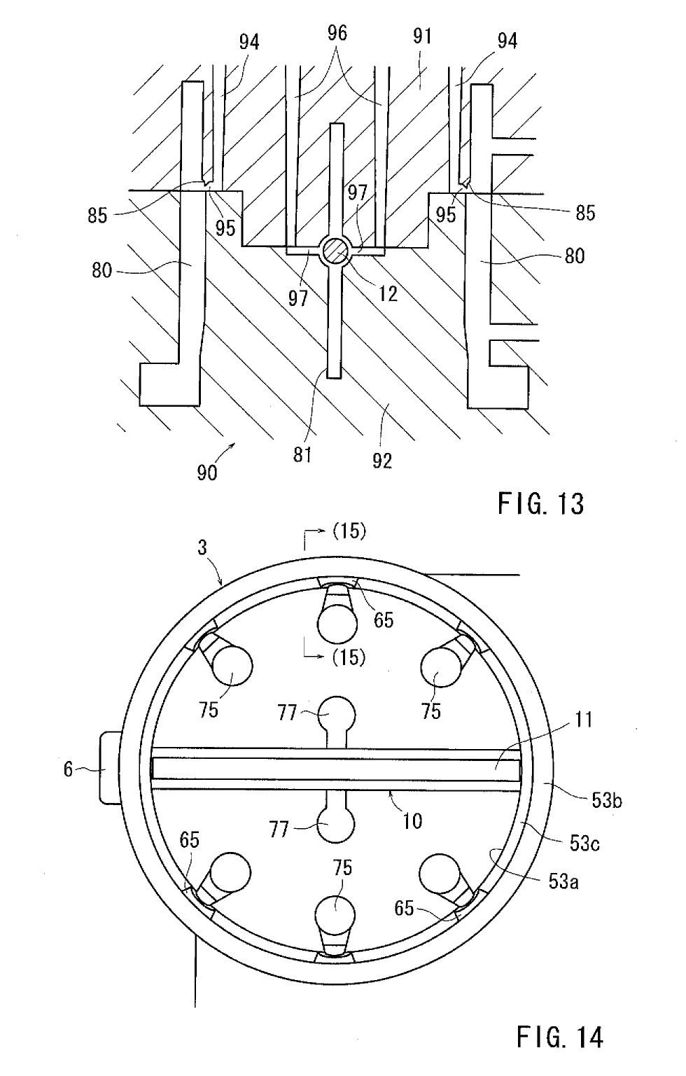

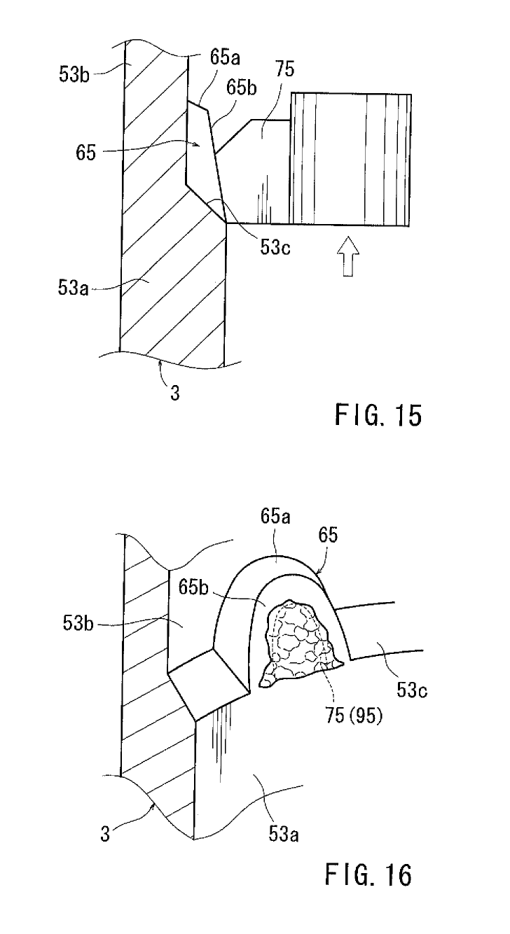

Referring to FIG. 13, a molding die 90 generally includes a stationary die part 91 and a movable die part 92, which cooperate to define a mold cavity when the movable die part 91 is moved to close the molding die 90. More specifically, a cavity 80 for molding the throttle body 2 and a cavity 81 for molding the throttle valve 10 are defined in the molding die 90 when the molding die 90 is closed. The molding die 90 is designed to be able to simultaneously mold the throttle body 2 and the throttle valve 10. FIG. 13 shows the cavity 80 in a vertical sectional view. As shown in FIG. 15, the bore wall portion 3 has a small diameter portion 53a and a large diameter portion 53b. An inner diameter of the small diameter portion 53a is smaller than that of the large diameter portion 53b. The small diameter portion 53a is formed in series with the large diameter portion 53b along a direction of flow of intake air via a stepped portion 53c that is configured as an inclined surface. The cavity 80 for molding the bore wall portion 3 is configured to conform to the configuration of the bore wall portion 3.

In an inner circumferential surface of the cavity 80 for molding the bore wall portion 3, a plurality of cavities 85 are formed to extend radially inward for molding bases 65. More specifically, the cavities 85 are formed at positions where the stepped portion 53c is molded. In addition, within the molding die 90, a plurality of runners 94 serving as flow passages of the molten resin are formed and communicate with the cavities 85 via injection gates 95, respectively, each of which is formed at one end of the corresponding runner 94. In other words, each of the injection gates 95 communicates with the cavity 80 (for molding the bore wall portion 3) via the corresponding cavity 85 (for molding the base 65). An end portion of each of the runners 94 is tapered toward the corresponding gate 95. Therefore, a cross sectional area of each injection gate 95 is smaller than a cross sectional area of the corresponding runner 94. The runners 94 are spaced equally from each other in the circumferential direction of the cavity 80. Similarly, the injection gates 95 are spaced equally from each other in the circumferential direction of the cavity 80. The cavities 85 for the bases 65 are positioned to correspond to the injection gates 95, respectively. In this example, six runners 94, six injection gates 95 and six cavities 85 are provided (see FIG. 14). In order to mold the throttle valve 3, molten resin is supplied into the cavity 81 from runners 96 via respective injection gates 97. The runners 96 are different from the runners 94. The injection gates 97 directly communicate with the cavity 81.

In this example, the bases 65 have the same configuration with each other. Therefore, the configuration of only one of the bases 65 will be described with reference to FIGS. 15 and 16. As shown in FIGS. 15 and 16, the base 65 has a bell-like cross sectional configuration. The cavity 85 for molding the base 65 have a configuration conforming to the configuration of the base 65. The injection gate 95 also has a bell-like cross sectional configuration similar to that of the base 65. However, the cross sectional area of the base 65 is larger than that of the injection gate 95. In other words, an external size of the base 65 is larger than the open area of the injection gate 95. Therefore, the cross sectional configuration of the base 65 and the cross sectional configuration of the injection gate 95 have a scaling relationship with each other. The base 65 extends from the smaller diameter portion 53a toward the large diameter portion 53b and has an inner circumferential surface 65b that extends in continuity with the inner circumferential surface of the small diameter portion 53a. An apex (curved portion) of the bell-like shape of the base 65 is positioned at the large diameter portion 53b. A side surface 65a of the base 65 is configured as an inclined surface, so that the cross sectional area of the base 65 increases in a direction from the side of the injection gate 95 toward the bore wall portion 3. Further, the thickness of the base 65 gradually decreases in a direction from the side of the small diameter portion 3a toward the large diameter portion 3b, so that the inner circumferential surface 65a of the base 65 is also inclined. In this example, the inner circumferential surface 65b of the base 65 is configured as an arc-shaped surface having the same radius of curvature as the bore wall portion 3.

An injection molding process using the molding die 90 will now be described. First, the throttle shaft 12 is inserted into the molding die 90 and is then fixed in position at the central portion of the cavity 81 for the throttle valve 13. After that, the movable die part 92 is moved toward the stationary die part 91 for closing the molding die 90, so that the mold cavity is defined within the molding die 90. Thereafter, molten resin is injected into the mold cavity 80 through the runners 94 via the injection gates 95 and is also injected into the mold cavity 81 through the runners 96 via the injection gates 97. As the molten resin is injected into the cavity 80 for molding the bore wall portion 3 via the injection gates 95 opposed to the stepped portion 53c, the molten resin is dispersed toward the side of the small diameter portion 53a and also toward the side of the large diameter portion 53b. The molten resin can smoothly flow even toward the side of the large diameter portion 53b because of the presence of the cavities 85 for the bases 65 and their specific configurations. Therefore, the flow resistance and the presser loss of the molten resin can be reduced. Hence, it is possible to maintain the resin pressure within the mold cavity at a high pressure than that available in the known art (for example, Publication No. 2006-44047 referred to in the background art) and can maintain such a high pressure for a long time. As a result, the resin density can be improved and the dimension accuracy of the throttle body 2 can be improved.

After solidification of the molten resin, a molded product (the throttle valve 10 and the throttle body 2 in this example) is removed from the molding die 90. However, the bore wall portion 3 of the molded throttle body 2 still has projections 75 formed at the inner circumferential wall of the bore wall portion 3. More specifically the projections 75 are molded by the injection gates 95 and the runners 94 communicating with the respective injection gates 95. Therefore, the projections 75 are necessary to be removed. For the removal of the projections 75, the projections 75 are bent and broken by applying forces from the side of the smaller diameter portion 53a. At the time of removing the projection 75, it may be possible that a portion around the projection 75 is ripped together with the projection 75. Thus, the ripping phenomenon may occur. However, according to the present example, the portion of the projection 75 formed at the injection gate 95 have a bell-like cross sectional configuration, and therefore, a stress applied to the projection 75 may be concentrated in a corner portion (an apex) of the bell-like shape of the cross section of the projection 75. Therefore, the ripping phenomenon may affect to only a limited extent. In addition, because the cross sectional area of the injection gate 95 is smaller than the cross sectional area of the runners 94, a smaller stress may be concentrated in the projection 75. Further, even in the case that the ripping phenomenon occurs, only the base 65 may be chipped at the worst, because the projection 75 is formed on the base 65, the cross sectional area of which is larger than that of the projection 75. Therefore, it is possible to reliably prevent the throttle body 2 from being broken or damaged. In this example, projections 77 formed at the throttle valve 10 and may be removed, for example, by cutting.

### Possible Modifications of Fifth Example

Although the molten resin is supplied through the runners 94 for molding the throttle body 2 and through the runners 96, which are different from the runners 94, for molding the throttle valve 10, it may be possible to configure such that the runners 94 are branched to communicate with the injection gates 97, for example, in the same manner as Publication No. 2006-44047. Further, it is possible to configure such that the injection gates 97 for the throttle valve 10 communicate with the cavity 81 through cavities for molding bases that may be similar to those described in connection with the first to fourth examples.

The positions of the bases 65 may not be limited to the positions shown in the above example if the throttle body 2 to be molded has a fixed inner diameter throughout the vertical length and has no stepped portion 53c. In addition, although six bases 65 are provided in the above example, the number of the bases 65 may be suitably selected between two and eight or more. Also in such a case, the bases 65 may preferably be spaced equally from each other along the inner circumference of the bore wall portion 3.

In addition, the cross sectional configuration of the injection gates 95 is not limited to the bell-shaped configuration as long as it is a non-circular configuration including at least one corner portion where a stress may be concentrated. For example, the cross sectional configuration may be a polygonal configuration, such as a triangular configuration and a rectangular configuration, a sectorial configuration or an oval configuration. It is only necessary that the cross sectional area of the gates 95 is not larger than that of the runners 94. Therefore, the cross sectional area of the gate 95 may be the same as that of the runners 94. The side surface of each base 65 is not necessary to be inclined and may be perpendicular to the bore wall portion 3. The base(s) 65 may be formed on the small diameter portion 53a or the large diameter portion 53b in addition to or in place of the stepped portion 53c. For example, the base(s) 65 may be formed on any two of the stepped portion 53c, the small diameter portion 53a and the large diameter portion 53b. However, in such a case, it may be preferable that at least the stepped portion 53c has the base(s) 65. It is not necessary that the inner circumferential surface of the base 65 is formed in continuity with the inner circumferential surface of the small diameter portion 53a. In addition, the inner circumferential surface of the base 65 is not necessary to be an arc-shaped surface but may be a flat surface. Further, the inner circumferential surface of the base 65 may extend parallel to the inner circumferential surfaces of the small diameter portion 53a and the large diameter portion 53b.

Further, the projections 75 formed at the injection gates 95 may be cut together with the bases 65. In such a case, it may be preferable to use a rotary cutting tool that can be slidably moved while being rotated for cutting the projections 75. An end mill may be used as the rotary cutting tool. During the rotary cutting operation of the base 65 by the end mill 21, a shearing force may be applied to the base 65 in a tangential direction of the end mill. Therefore, it may be possible that the shearing force breaks the base 65. However, by configuring the side surface 65a of the base 65 such that the base 65 is enlarged toward the bore wall portion 3, the thickness of the base 65 is large in the direction of application of the shearing force. As a result, the base 65 is hard to be broken.

What is claimed is:

1. A method of manufacturing a throttle valve of a throttle device used for controlling a flow rate of intake air supplied to an internal combustion engine, the throttle valve being rotatably supported by the throttle device and having a valve body and a throttle shaft defining a rotational axis, the valve body including a cylindrical tubular shaft cover portion and a pair of semicircular disk-shaped portions extending from the shaft cover portion in opposite directions from each other, the method comprising:
providing a molding die for molding the throttle valve;
wherein the molding die includes a mold cavity defined therein:
wherein the mold cavity includes a base cavity portion for molding a base on a surface of the shaft cover portion;
wherein the molding die further includes an injection gate, from which molten resin is injected, the injection gate communicating with the base cavity portion; and
wherein a cross sectional configuration of the injection gate includes at least a corner portion;
inserting the throttle shaft into the mold cavity; and
injecting molten resin into the mold cavity through the injection gate and the base cavity portion.

2. The method as in claim 1, wherein a cross sectional area of the injection gate is smaller than a cross sectional area of a runner that supplies molten resin into the injection gate.

3. The method as in claim 1, wherein the injection gate has a bell-like cross sectional configuration.

4. The method as in claim 1, wherein:
the base includes a first base and a second base;
the injection gate includes a first injection gate and a second injection gate;
the base cavity portion includes a first base cavity portion and a second base cavity portion for molding the first base and the second base, respectively;
the first injection gate and the first base cavity portion are disposed on a first side;
the second injection gate and the second base cavity portion are disposed on a second side opposite to the first side with respect to the throttle shaft in a direction perpendicular to an axial direction of the throttle shaft;
the mold cavity further includes:
a first cover cavity portion and a second cover cavity portion for molding the shaft cover portion; and
a first disk cavity portion and a second disk cavity portion for molding the pair of semicircular disk-shaped portions;
the first base cavity portion and the first injection gate are positioned to be opposed to a top portion of the first cover cavity portion;
the second base cavity portion and the second injection gate are positioned to be opposed to a top portion of the second cover cavity portion; and
the first and second injection gates are offset from each other in opposite directions along extending directions of the first and second disk cavity portions, with respect to a first central line passing through an axial center of the throttle shaft and extending perpendicular to the extending directions of the first and second disk cavity portions.

5. The method as in claim 4, wherein:
the first base cavity extends from the top of the first cover cavity portion in an offsetting direction of the first injection gate; and
the second base cavity extends from the top of the second cover cavity portion in an offsetting direction of the second injection gate.

6. The method as in claim 1, wherein the cross sectional configuration of the base is similar to or identical with the cross sectional configuration of the injection gate.

7. The method as in claim 4, wherein:
the first and second disk cavity portions are offset from each other in opposite directions with respect to a second central line passing through the axial center of the throttle shaft in parallel to the extending directions of the first and second disc cavity portions;
the first disk cavity portion and the first injection gate are offset toward each other; and
the second disk cavity portion and the second injection gate are offset toward each other.

8. The method as in claim 1, wherein a diameter of a portion of the throttle shaft opposed to the injection gate is smaller than a diameter of the remaining portion of the throttle shaft.

9. The method as in claim 1, further comprising removing a projection molded at the injection gate by bending and breaking the projection after solidification of the molten resin.

10. The method as in claim 1, wherein:
the base has a side surface inclined such that the cross sectional area of the base increases from the side of the injection gate toward the side of the shaft cover portion; and
the method further comprises cutting the base by a rotary cutting tool after solidification of the molten resin.

11. A method of manufacturing a throttle valve of a throttle device used for controlling a flow rate of intake air supplied to an internal combustion engine, the throttle valve being rotatably supported by the throttle device and having a valve body and a throttle shaft defining a rotational axis, the valve body including a cylindrical tubular shaft cover portion and a pair of semicircular disk-shaped portions extending from the shaft cover portion in opposite directions from each other, the method comprising:
providing a molding die for molding the throttle valve;
wherein the molding die includes a mold cavity defined therein:
wherein the mold cavity includes a base cavity portion for molding a base on a surface of the shaft cover portion;
wherein the molding die further includes an injection gate, from which molten resin is injected, the injection gate communicating with the base cavity portion; and
wherein the base has a side surface inclined such that the cross sectional area of the base increases from the side of the injection gate toward the side of the shaft cover portion;
inserting the throttle shaft into the mold cavity;
injecting molten resin into the mold cavity through the injection gate and the base cavity portion; and
cutting the base by a rotary cutting tool after solidification of the molten resin.

12. A method of manufacturing a throttle body of a throttle device used for controlling a flow rate of intake air supplied to an internal combustion engine, the throttle body including a cylindrical tubular bore wall portion defining an intake air passage therein, the method comprising:
providing a molding die for molding the throttle body;
wherein the molding die includes a mold cavity defined therein:
wherein the mold cavity includes a base cavity portion for molding a base projecting from an inner circumferential surface of the bore wall portion;
wherein the molding die further includes an injection gate, from which molten resin is injected, the injection gate communicating with the base cavity portion; and
wherein a cross sectional configuration of the injection gate includes at least one corner portion; and
injecting molten resin into the mold cavity through the injection gate and the base cavity portion.

13. The method as in claim 12, wherein a cross sectional area of the injection gate is smaller than a cross sectional area of a runner that supplies molten resin into the injection gate.

14. The method as in claim 12, wherein an external size of the base is larger than the cross sectional area of the injection gate.

15. The method as in claim 12, wherein a cross sectional configuration of the base is the same as a cross sectional configuration of the injection gate.

16. The method as in claim 12, wherein the injection gate has a bell-like cross sectional configuration.

17. The method as in claim 12, wherein:
the base has a side surface inclined such that a cross sectional area of the base increases from the side of the injection gate toward the side of the bore wall portion.

18. The method as in claim 12, wherein:
the bore wall portion includes a small diameter portion and a large diameter portion having different inner diameters from each other and formed in series with each other via a stepped portion having an inclined surface; and
the base projects from the stepped portion.

19. The method as in claim 18, wherein:
the base extends from the small diameter portion to the large diameter portion; and
the base has an inner circumferential surface extending in continuity with an inner circumferential surface of the small diameter portion.

20. The method as in claim 19, wherein the base has a thickness decreasing from the side of the small diameter portion toward the side of the large diameter portion, so that the inner circumferential surface of the base is inclined.

21. The method as in claim 12, wherein the base has an inner circumferential surface configured as an arc-shaped surface having a same radius of curvature as that of the bore wall portion.

22. The method as in claim 12, wherein the method further comprises bending and breaking a projection formed at the injection gate after solidification of the molten resin.

23. The method as in claim 22, wherein the at least one corner portion of the injection gate is positioned on the rear side with respect to a direction for bending and breaking the projection.
